(19) United States
(12) Patent Application Publication
(10) Pub. No.: US 2017/0344909 A1
(43) Pub. Date: Nov. 30, 2017

(54) MACHINE LEARNING DEVICE, FAILURE PREDICTION DEVICE, MACHINE SYSTEM AND MACHINE LEARNING METHOD FOR LEARNING END-OF-LIFE FAILURE CONDITION

(71) Applicant: FANUC CORPORATION, Yamanashi (JP)

(72) Inventors: Yuuki KUROKAWA, Yamanashi (JP); Tetsurou MATSUDAIRA, Yamanashi (JP); Yoshikiyo TANABE, Yamanashi (JP)

(21) Appl. No.: 15/598,312

(22) Filed: May 18, 2017

(30) Foreign Application Priority Data
May 27, 2016 (JP) 2016-106428

(51) Int. Cl. G06N 99/00; G06N 5/04

(52) U.S. Cl. CPC G06N 99/005; G06N 5/04

(57) ABSTRACT

A machine learning device learning a condition associated with an end-of-life failure of an electronic component in network-connected equipment connected to a network, including a state observation unit that observes a state variable obtained based on at least one of a hardware configuration, manufacturing information, an operating status, a use condition, and an output from a sensor detecting a state of a surrounding environment of the network-connected equipment; a determination data acquisition unit that acquires determination data on determination of presence or absence of the end-of-life failure or a degree of the end-of-life failure of the electronic component in the network-connected equipment; and a learning unit that learns, based on training data created from an output from the state observation unit and an output from the determination data acquisition unit, and teacher data, a condition associated with the end-of-life failure of the electronic component in the network-connected equipment.

### BACKGROUND OF THE INVENTION

### 1. Field of the Invention

The present invention relates to a machine learning device, a failure prediction device, a machine system and a machine learning method for learning an end-of-life failure condition.

### 2. Description of the Related Art

In recent years, equipment such as a numerical control (NC) device, a computerized numerical control (CNC) device, a robot and a programmable logic controller (PLC) is connected to a network. The network-connected equipment uses many electronic components. The electronic components have their life, and when the life is short and thus problematic, the equipment (electronic component) needs periodic replacement.

The replacement cycle of a life-limited electronic component is conventionally determined based on, for example, an estimation value, an experience value, and the like obtained by a life test. However, since the life of the electronic component actually varies significantly with an operating status, a use condition and the like of equipment, the electronic component may fail, for example, before replacement.

Incidentally, as a technique that enables prompting replacement of a life-limited component at an optimal timing, a component service life management system has been conventionally proposed, in which to sample and acquire, via the Internet, service life characteristic data of a life-limited component used in equipment, calculate remaining life by using life analysis software, and determine replacement time (for example, Japanese Laid-Open Patent Publication No. 2003-157330: Patent Document 1).

As described above, for example, Patent Document 1 enables prompting replacement of a life-limited component at an optimal timing. However, in such a component service life management system, when a life-limited component in use in another company's equipment or the like is unknown, for example, it is difficult to manage an end-of-life failure of an electronic component.

Further, it is currently difficult to acquire presence or absence of an end-of-life failure or a degree of a failure of an electronic component in network-connected equipment connected to a network, and perform replacement of a life-limited component at an optimal timing.

In light of the problem in the above-described conventional technique, an object of the present invention is to provide a machine learning device, a failure prediction device, a machine system and a machine learning method capable of knowing presence or absence of an end-of-life failure or a degree of a failure of an electronic component in network-connected equipment.

### SUMMARY OF INVENTION

According to a first aspect of the present invention, there is provided a machine learning device learning a condition associated with an end-of-life failure of an electronic component in network-connected equipment, including a state observation unit that observes a state variable obtained based on at least one of a hardware configuration, manufacturing information, an operating status, a use condition, and an output from a sensor detecting a state of a surrounding environment of the network-connected equipment; a determination data acquisition unit that acquires determination data on determination of presence or absence of the end-of-life failure or a degree of the end-of-life failure of the electronic component in the network-connected equipment; and a learning unit that learns, based on training data created from an output from the state observation unit and an output from the determination data acquisition unit, and teacher data, a condition associated with the end-of-life failure of the electronic component in the network-connected equipment.

The learning unit may include an error calculation unit that calculates an error between the training data and the teacher data; and a learning model update unit that updates, based on an output from the state observation unit, an output from the determination data acquisition unit and an output from the error calculation unit, a learning model defining an error in the condition associated with the end-of-life failure of the electronic component in the network-connected equipment.

The machine learning device may be present on a fog server. The fog server may control at least one cell including pieces of equipment via a first network. The machine learning device may be present on a cloud server. The cloud server may control, via a second network, at least one fog server to which at least one cell including pieces of equipment is linked via a first network.

The machine learning device may be connectable with at least another one machine learning device to mutually exchange or share a result of machine learning with at least the other one machine learning device. The machine learning device may include a neural network.

According to a second aspect of the present invention, there is provided a failure prediction device including the machine learning device according to the above described first aspect and predicting the end-of-life failure of the electronic component in the network-connected equipment, including a failure information output unit that receives an output from the machine learning device, and outputs, based on the current state variable observed by the state observation unit, failure information representing presence or absence of the end-of-life failure or the degree of the end-of-life failure of the electronic component in the network-connected equipment. The failure information output unit may output a notification of failure prediction or a notification of maintenance information on an electronic component in the network-connected equipment.

According to a third aspect of the present invention, there is provided a machine system including the failure prediction device according to the above described second aspect; and the network-connected equipment.

According to a fourth aspect of the present invention, there is provided a machine learning method of learning a condition associated with an end-of-life failure of an electronic component in network-connected equipment connected to a network, including observing a state variable obtained based on at least one of a hardware configuration, manufacturing information, an operating status, a use condition, and an output from a sensor detecting a state of a surrounding environment of the network-connected equipment; acquiring determination data on determination of presence or absence of the end-of-life failure or a degree of the end-of-life failure of the electronic component in the network-connected equipment; and learning, based on training data created from the observed state variable and the acquired determination data, and teacher data, a condition associated with the end-of-life failure of the electronic component in the network-connected equipment. The learning the condition associated with the end-of-life failure of the electronic component in the network-connected equipment may include calculating an error between the training data and the teacher data; and updating, based on the observed state variable, the acquired determination data, and the calculated error, a learning model defining an error in a condition associated with the end-of-life failure of the electronic component in the network-connected equipment. The learned condition associated with the end-of-life failure of the electronic component in the network-connected equipment may be mutually exchanged or shared between at least two machine learning devices. The machine learning method may further include outputting, based on a learned condition associated with an end-of-life failure of an electronic component in the network-connected equipment, a notification of failure prediction or a notification of maintenance information on an electronic component in the network-connected equipment.

### BRIEF DESCRIPTION OF THE DRAWINGS

The present invention will be more clearly understood by reference to the accompanying drawings, in which:

FIG. 1 is a block diagram illustrating one embodiment of a machine learning device according to the present invention;

FIG. 2 is a block diagram illustrating one example of a failure prediction device applied with the machine learning device illustrated in FIG. 1; and

FIG. 3 is a block diagram illustrating one example of a network to be applied with the machine learning device according to the present invention.

### DETAILED DESCRIPTION

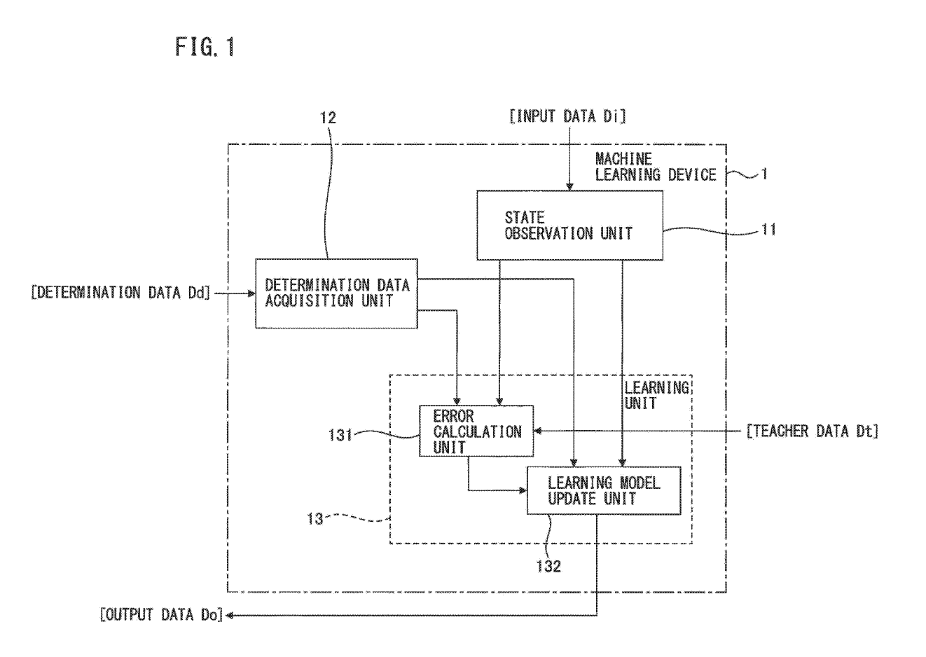

An embodiment of a machine learning device, a failure prediction device, a machine system and a machine learning method according to the present invention in detail with reference to the accompanying drawings. FIG. 1 is a block diagram illustrating one embodiment of a machine learning device according to the present invention. Herein, the machine learning device 1 illustrated in FIG. 1 is applied with supervised learning, and learns, as will be described later, a condition associated with an end-of-life failure of an electronic component in equipment (2a to 2c and 21 to 23) connected to a network (5 and 7).

The supervised learning refers to learning a certain feature in teacher data, i.e., a large number of datasets of certain inputs and results (labels) given to a machine learning device, and inductively acquiring a model (learning model) for estimating a result from an input, i.e., a relationship between the input and the result.

In other words, as illustrated in FIG. 1, the machine learning device 1 includes a state observation unit 11, a determination data acquisition unit 12, and a learning unit 13. The state observation unit 11 receives input data Di, and the determination data acquisition unit 12 acquires determination data Dd on determination of presence or absence of an end-of-life failure or a degree of an end-of-life failure of an electronic component in the network-connected equipment. Herein, the input data Di includes, for example, at least one of a hardware configuration, manufacturing information, an operating status, a use condition, and an output from a sensor detecting a state of a surrounding environment of the network-connected equipment. The determination data Dd includes, for example, data on determination of presence or absence of an end-of-life failure or a degree of an end-of-life failure of an electronic component in the network-connected equipment.

The learning unit 13 receives an output from the state observation unit 11 and an output from the determination data acquisition unit 12, creates training data, and learns, based on the training data and externally input teacher data Dt, a condition associated with an end-of-life failure of an electronic component in the network-connected equipment (hereinafter, also referred to simply as an electronic component). In other words, as illustrated in FIG. 1, the learning unit 13 includes an error calculation unit 131 and a learning model update unit 132, wherein the error calculation unit 131 calculates an error between the training data and the teacher data Dt, and the learning model update unit 132 receives an output from the state observation unit 11, an output from the determination data acquisition unit 12, and an output from the error calculation unit 131 and updates a learning model defining an error in a condition associated with an end-of-life failure of an electronic component.

Herein, the machine learning device 1 can be implemented by using, for example, an algorithm of a neural network or the like. In addition, the machine learning device 1, which can also use a general-purpose computer or processor, can be applied with, for example, GPGPU (General-Purpose computing on Graphics Processing Units) and a large-scale PC cluster to implement faster processing.

As the teacher data, for example, when identical equipment (or a machine system), or the like is caused to perform an identical work, labeled data obtained by the day before a certain day on which the work is actually performed can be held and provided as the teacher data to the error calculation unit 131 on the certain day. Alternatively, for example, data obtained by a simulation or the like performed outside a machine system, or labeled data of another machine system (equipment) can be also provided as the teacher data to the error calculation unit 131 of the machine learning device 1 by means of a memory card or a communication line. Further, the teacher data (labeled data) can be also held in, for example, a non-volatile memory such as Flash Memory built in the learning unit 13, so that the learning unit 13 can use the labeled data held in the non-volatile memory as is.

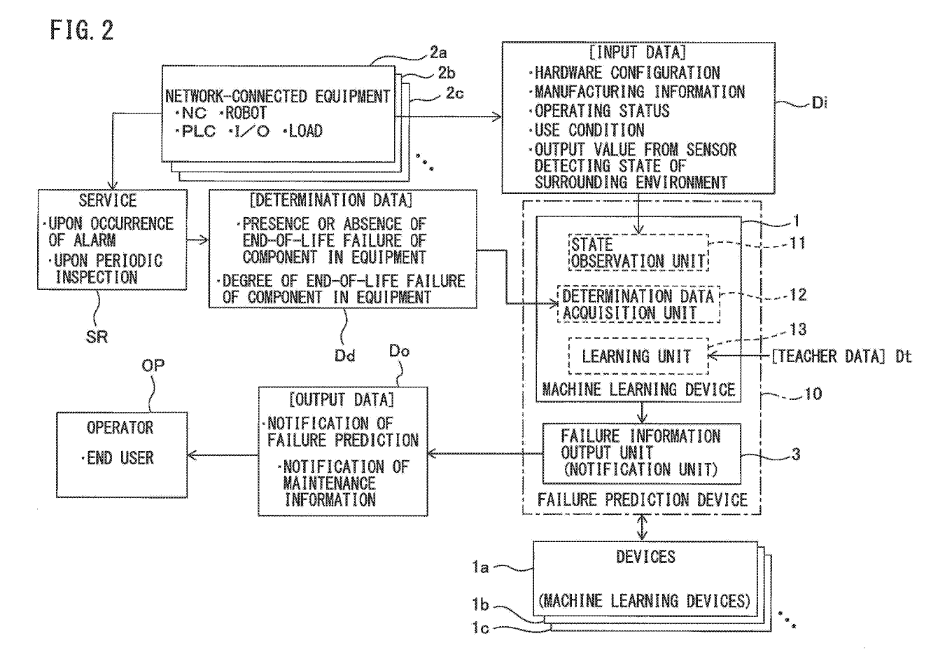

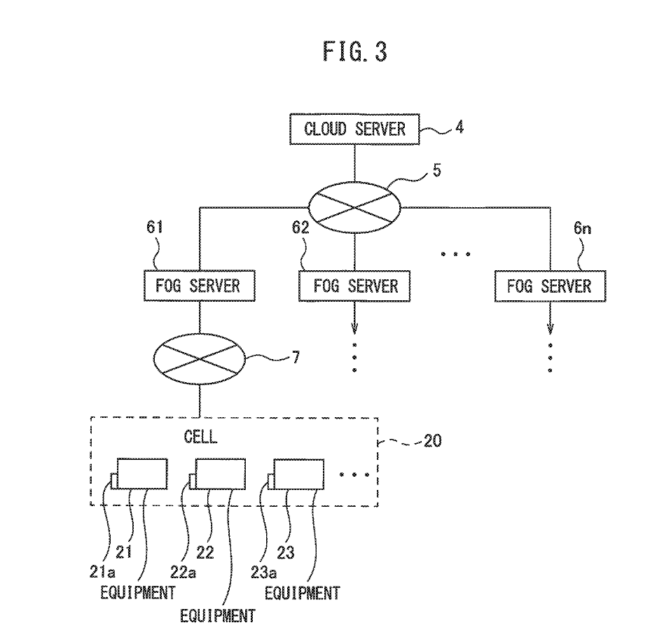

FIG. 2 is a block diagram illustrating one example of a failure prediction device applied with the machine learning device illustrated in FIG. 1, and FIG. 3 is a block diagram illustrating one example of a network to be applied with the machine learning device according to the present invention. As illustrated in FIG. 2, the failure prediction device 10 predicts an end-of-life failure of an electronic component in equipment 2a, 2b, 2c, . . . connected to a network 5 and 7, and includes the machine learning device 1 and a failure information output unit (notification unit) 3. Herein, as illustrated in FIG. 3, the machine learning device 1 (the failure prediction device 10) can be provided in, for example, a cloud server 4, each of fog servers 61 to 6n, or any one of the fog servers 61 to 6n. In addition, the machine learning device 1 can be also provided in each piece of equipment (terminals, edges) 21, 22, 23, . . . , to perform distributed learning.

In FIG. 3, a cell (e.g., an industrial machine cell) 20 includes pieces of equipment (e.g., industrial machines such as NC devices and industrial robots) 21, 22, 23, . . . , and these pieces of equipment 21, 22, 23, . . . are linked to the fog server 61 via the network 7. A plurality of cells 20 are provided in, for example, one factory and a machine system includes, for example, a plurality of cells, but it is needless to say that various modifications and changes can be made to the configurations.

Herein, the machine learning device 1 (1a, 1b, 1c, . . . ) can be provided on, for example, each of the fog servers 61 to 6n to mutually exchange or share a result of learning by each of the machine learning devices 1a, 1b, 1c, . . . via the network 5. Mutually exchanging or sharing a result of learning by each of the machine learning devices 1a, 1b, 1c, . . . in this manner makes it possible to improve a learning effect.

The network 7 may be configured to be linked with a plurality of cells 20 each including pieces of equipment 21, 22, 23, . . . , and the network may be configured as a network of three or more layers, without limitation to two layers of 5 and 7. The machine system according to the present invention is constituted by including the failure prediction device 10 illustrated in FIG. 2 and the equipment 21, 22, 23, . . . (2a, 2b, 2c, . . . ) connected to the network 7 (5) illustrated in FIG. 3.

As illustrated in FIG. 2, input data Di that the state observation unit 11 observes includes, for example, at least one of a hardware configuration, manufacturing information, an operating status and a use condition of the equipment 2a, 2b, 2c, . . . (21, 22, 23, . . . ) connected to the network (5 and 7), and an output from a sensor (21a, 22a, 23a, . . . ) detecting a state of a surrounding environment of the network-connected equipment 2a, 2b, 2c, . . . . The input data Di, which can be also acquired by the state observation unit 11 (the machine learning device 1) via a network, may be notified by, for example, an operator (OP) directly to the machine learning device 1.

Herein, the “hardware configuration” means the configuration of a device (equipment), and, for example, a single CNC device is formed by combining multiple devices. In addition, the “manufacturing information” means the date of manufacture, and the “operating status” means time during which the power of a device is on or time during which a signal is on (activated). Further, the “use condition” means a voltage and a current in use in a life-limited component. The “output from a sensor detecting a state of a surrounding environment” means, for example, an output from the sensor 21a, 22a, 23a, . . . provided in (or provided around) the pieces of equipment 21, 22, 23, . . . included in the cell 20 in FIG. 3. In addition, as the sensor 21a, 22a, 23a, . . . , for example, various sensors are applicable such as a temperature sensor, a humidity sensor or a vibration sensor.

The equipment 21, 22, 23, . . . (2a, 2b, 2c, . . . ) connected to the network 5 and 7 includes various equipment, such as an NC device (CNC device), a robot (industrial robot), a programmable logic controller (PLC), an Input/Output (I/O) module, and a load device. The input data Di that the state observation unit 11 observes may include all of a hardware configuration, manufacturing information, an operating status and a use condition of the equipment 21, 22, 23, . . . connected to the network 5 and 7, and an output from the sensor 21a, 22a, 23a, . . . detecting a state of a surrounding environment of the equipment 21, 22, 23, . . . connected to the network 5 and 7.

As illustrated in FIG. 2, determination data Dd that the determination data acquisition unit 12 acquires includes failure information representing presence or absence of an end-of-life failure or a degree of an end-of-life failure of an electronic component in the network-connected equipment 2a, 2b, 2c, . . . . The determination data Dd can be acquired by, for example, a service (upon occurrence of an alarm, upon periodic inspection, or the like) SR of the network-connected equipment 2a, 2b, 2c, . . . .

In addition, as illustrated in FIG. 2, the failure information output unit 3 of the failure prediction device 10 receives an output from the machine learning device 1 (the learning unit 13), and outputs, based on a current state variable observed by the state observation unit 11, failure information representing presence or absence of an end-of-life failure or a degree of an end-of-life failure of an electronic component in the network-connected equipment 2a, 2b, 2c, . . . as output data Do to the operator (end user) OP. In other words, the failure information output unit 3 (the failure prediction device 10) outputs, based on a result of learning a condition associated with an end-of-life failure of an electronic component in the network-connected equipment by the machine learning device 1, a notification of failure prediction or a notification of maintenance information on an electronic component in the network-connected equipment 2a, 2b, 2c, . . . to the operator OP. Accordingly, the operator OP is able to recognize failure prediction or maintenance information on an electronic component in the network-connected equipment and perform replacement and maintenance of the electronic component before occurrence of a failure.

The following describes when the machine learning device 1 (the failure prediction device 10) is implemented in a cell controller (e.g., the fog server 61) with reference to FIG. 2 and FIG. 3. First, the cell controller (the machine learning device 1) and the equipment 21, 22, 23, . . . (2a, 2b, 2c, . . . ) such as an NC device is connected by the network 7. The machine learning device 1 (the fog server 61) observes, via the network 7, input data Di such as a hardware configuration, manufacturing information, an operating status and a use condition of the equipment 21, 22, 23, . . . , and a state of a surrounding environment of the equipment 21, 22, 23, . . . (an output from the sensor 21a, 22a, 23a, . . . provided in the equipment 21, 22, 23, . . . ) by means of the state observation unit 11. Herein, for example, a hardware configuration, manufacturing information, an operating status, and a use condition of equipment may be notified by the operator (OP) directly to the cell controller (the machine learning device 1).

Next, upon occurrence of an alarm or upon periodic inspection of the equipment 21, 22, 23, . . . connected to the network 7, presence or absence of an end-of-life failure or a degree of an end-of-life failure of an electronic component in the equipment 21, 22, 23, . . . is notified as determination data Dd to the cell controller (the machine learning device 1, the determination data acquisition unit 12). Herein, when an end-of-life failure is present or when an end-of-life failure is in progress, the machine learning device 1 (the learning unit 13) creates training data based on a state variable at the time and the determination data, and learns, based on the training data and teacher data Dt, a condition associated with an end-of-life failure of an electronic component in the equipment 21, 22, 23, . . . connected to the network 7. Accordingly, observing a current state variable makes it possible to know current presence or absence of an end-of-life failure or a current degree of a failure of the equipment.

According to the machine learning device, the failure prediction device, the machine system and the machine learning method according to the present invention, it is possible to provide an advantageous effect of being able to know presence or absence of an end-of-life failure or a degree of a failure of an electronic component in network-connected equipment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A machine learning device learning a condition associated with an end-of-life failure of an electronic component in network-connected equipment connected to a network, comprising:
a state observation unit that observes a state variable obtained based on at least one of a hardware configuration, manufacturing information, an operating status, a use condition, and an output from a sensor detecting a state of a surrounding environment of the network-connected equipment;
a determination data acquisition unit that acquires determination data on determination of presence or absence of the end-of-life failure or a degree of the end-of-life failure of the electronic component in the network-connected equipment; and
a learning unit that learns, based on training data created from an output from the state observation unit and an output from the determination data acquisition unit, and teacher data, a condition associated with the end-of-life failure of the electronic component in the network-connected equipment.

2. The machine learning device according to claim 1, wherein
the learning unit comprises:
an error calculation unit that calculates an error between the training data and the teacher data; and
a learning model update unit that updates, based on an output from the state observation unit, an output from the determination data acquisition unit and an output from the error calculation unit, a learning model defining an error in the condition associated with the end-of-life failure of the electronic component in the network-connected equipment.

3. The machine learning device according to claim 1, wherein
the machine learning device is present on a fog server.

4. The machine learning device according to claim 3, wherein
the fog server controls at least one cell including pieces of equipment via a first network.

5. The machine learning device according to claim 1, wherein
the machine learning device is present on a cloud server.

6. The machine learning device according to claim 5, wherein
the cloud server controls, via a second network, at least one fog server to which at least one cell including pieces of equipment is linked via a first network.

7. The machine learning device according to claim 1, wherein
the machine learning device is connectable with at least another one machine learning device to mutually exchange or share a result of machine learning with at least the other one machine learning device.

8. The machine learning device according to claim 1, wherein
the machine learning device comprises a neural network.

9. A failure prediction device including the machine learning device according to claim 1 and predicting the end-of-life failure of the electronic component in the network-connected equipment, comprising
a failure information output unit that receives an output from the machine learning device, and outputs, based on the current state variable observed by the state observation unit, failure information representing presence or absence of the end-of-life failure or the degree of the end-of-life failure of the electronic component in the network-connected equipment.

10. The failure prediction device according to claim 9, wherein
the failure information output unit outputs a notification of failure prediction or a notification of maintenance information on an electronic component in the network-connected equipment.

11. A machine system comprising:
the failure prediction device according to claim 9; and
the network-connected equipment.

12. A machine learning method of learning a condition associated with an end-of-life failure of an electronic component in network-connected equipment connected to a network, comprising:
observing a state variable obtained based on at least one of a hardware configuration, manufacturing information, an operating status, a use condition, and an output from a sensor detecting a state of a surrounding environment of the network-connected equipment;
acquiring determination data on determination of presence or absence of the end-of-life failure or a degree of the end-of-life failure of the electronic component in the network-connected equipment; and
learning, based on training data created from the observed state variable and the acquired determination data, and teacher data, a condition associated with the end-of-life failure of the electronic component in the network-connected equipment.

13. The machine learning method according to claim 12, wherein
the learning the condition associated with the end-of-life failure of the electronic component in the network-connected equipment comprises:
calculating an error between the training data and the teacher data; and
updating, based on the observed state variable, the acquired determination data, and the calculated error, a learning model defining an error in a condition associated with the end-of-life failure of the electronic component in the network-connected equipment.

14. The machine learning method according to claim 12, wherein
the learned condition associated with the end-of-life failure of the electronic component in the network-connected equipment is mutually exchanged or shared between at least two machine learning devices.

15. The machine learning method according to claim 12, further comprising
outputting, based on a learned condition associated with an end-of-life failure of an electronic component in the network-connected equipment, a notification of failure prediction or a notification of maintenance information on an electronic component in the network-connected equipment.
